(19) United States
(12) Patent Application Publication
(10) Pub. No.: US 2024/0229847 A1
(43) Pub. Date: Jul. 11, 2024

(54) Ceramic Tile Seam Nail

(71) Applicant: Fangqiong HU, Shanghai (CN)

(72) Inventor: Fangqiong HU, Shanghai (CN)

(21) Appl. No.: 16/336,680

(22) PCT Filed: Oct. 10, 2017
(86) PCT No.: PCT/CN2017/105478

§ 371 Date: Nov. 22, 2021

(30) Foreign Application Priority Data
Feb. 21, 2017 (CN) 20172015363.3

(51) Int. Cl. F16B 15/00; A47B 96/06; F16B 45/00

(52) U.S. Cl. CPC F16B 15/0053; A47B 96/06; F16B 2015/0076; F16B 45/00

(57) ABSTRACT

A ceramic tile seam nail is a special nail for people to fix hooks, shelves, etc by utilizing the ceramic tile seams on the ceramic tile wall in kitchen and bathroom without perforation. The first embodiment: the needle bodies (1) penetrate the circular cylindrical body (2), one end of the circular cylindrical body (2) has a screw thread (3) with a corresponding screw cap (4), the needle bodies (1) can be arranged in a line, this embodiment can adapt to all directions of ceramic tile seams; there are the longitudinal bulges (5) or the longitudinal grooves (6) from the adjacent screw thread (3) to the other end on the circular cylindrical body (2), this is the second embodiment; there are holes (7) on the circular cylindrical body (2), this is the third embodiment; the second and third embodiments can adapt to the horizontal and vertical ceramic tile seams, and can achieve that a single nail fixes an object; the fourth embodiment of the ceramic tile seam nail: the needle bodies (1) penetrate the square body (9) on which are holes (7) or transverse groove (8). This embodiment also breaks the existing method that two nails are necessary to fix an object.

### FIELD

The present invention relates to a scheme for fixing hooks and shelves on ceramic tile walls in kitchens and bathrooms without perforating to hurt the ceramic tile surfaces by utilizing the characteristics of ceramic tile seams.

### BACKGROUND

At present, Fixing hooks, shelves, etc on the ceramic tile walls in kitchen. bathroom requires a professional person to use a special tool to drill a hole, which brings many inconveniences to ordinary families: some hooks, shelves, etc adopts the scheme of adhesive or sucker also, both of which are not 100% ideal.

The width of the ceramic tile seams generally is 0.7 mm or more; many ceramic tile seams on the walls in kitchen and bathroom pass through the comfort zone from which people pick up things, this creates the feasibility of the invention. The invention provides more choices to facilitate people's daily lives.

### DETAIL OF THE INVENTION

The present invention is for fixing hooks, shelves, etc by adapting to the width and the orientation of the ceramic tile seams and the sturdy features of the ceramic tile to create a kind of nail.

The first embodiment of the invention consists of four parts: the needle bodies (1), the circular cylindrical body (2), the screw thread (3), and the screw cap (4), as shown in FIG. 1. The needle bodies are made of fine and hard steel material. The sewing needle provides a good application for people to experience.

The number of the needle bodies (1) is unlimited and arranged as required. wherein including in a line; the needle bodies (1) can be integrated with the circular cylindrical body (2) to be one body, or be separated from the circular cylindrical body (2) to be two parts, generates relationship with the circular cylindrical body (2) by penetrating the circular cylindrical body (2), as shown in FIG. 5. The separating type are helpful to better implement of the invention, for instance, it is not easy to make the needle bodies askew, or to hit fingers by hammer, etc. The method is also applicable to the following embodiments.

The second embodiment: In addition to including all the above features, the longitudinal bulges (5) or the longitudinal grooves (6) are created on the circular cylindrical body (2) in the second embodiment, as shown in (5) and (6) in FIG. 2. The structure makes it easy to fix a small shelf (such as soap shelf, hair dryer shelf, etc.) by a single ceramic tile seam nail, effectively preventing the shelf from rotating around the circular cylindrical body (2), and meanwhile takes into account the orientations of the tile seams and the shelves The structure which the cross-shaped longitudinal bulges (5) or longitudinal grooves (6) are symmetrical with needle bodies (1) as axis is the optimal scheme to achieve this goal.

Because of the different fixing methods between the ceramic tile seam nails and the shelves, the third and fourth embodiments are invented.

The third embodiment: composed of needle bodies (1) and a circular cylindrical body (2), as shown in FIG. 3. Holes (7) are made on the body of circular cylinder (2) to fix the shelf, the number of the holes is unlimited. Multi holes are made to take into account the orientations of both ceramic tile seams and shelf to increase flexibility. For example, four holes are made along four directions on the cylindrical body (2) symmetrically with the needle bodies (1) as axis.

The fourth embodiment: composed of needles (1) and a square body (9), as shown in FIG. 4. The square body (9) can be perforated by the same method as the above embodiment; or can be transversely grooved, named the transverse groove (8) to fix the shelves effectively. The transverse groove (8) also takes into consideration of the directions of tile seams and shelves effectively, to further increase flexibility.

All existing nails in home decoration can not achieve that a single nail fix the object (the object can rotate around the nail). The second embodiment, the third embodiment and the fourth embodiment break the existing mode that two nails are required to fix an object, and make the fixing simple and beautiful.

### BRIEF DESCRIPTION OF THE DRAWINGS

FIG. 1 is an overall perspective view of the first embodiment of the invention.

FIG. 2 is a perspective view of the circular cylindrical body (2) of the second embodiment.

FIG. 3 is a perspective view of the third embodiment;

FIG. 4 is a perspective view of the fourth embodiment;

FIG. 5 is a perspective view of the structure relationship between the needle bodies and the circular cylindrical body.

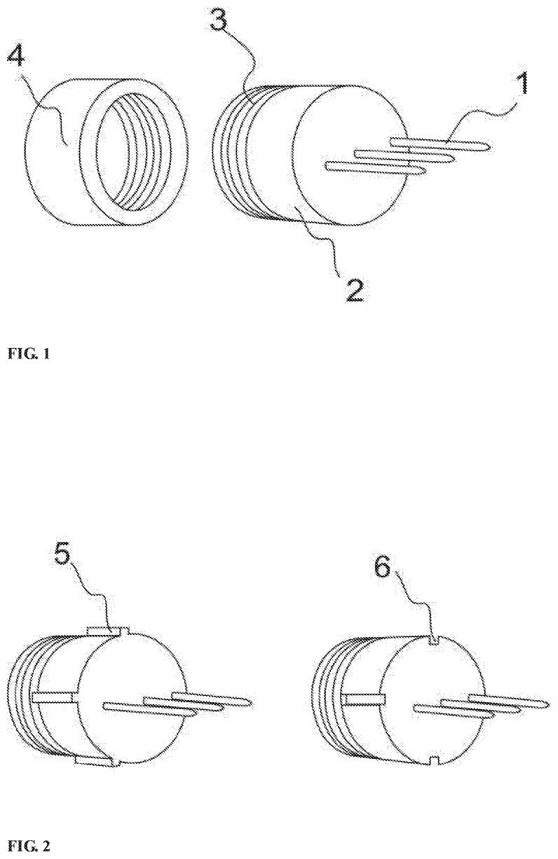

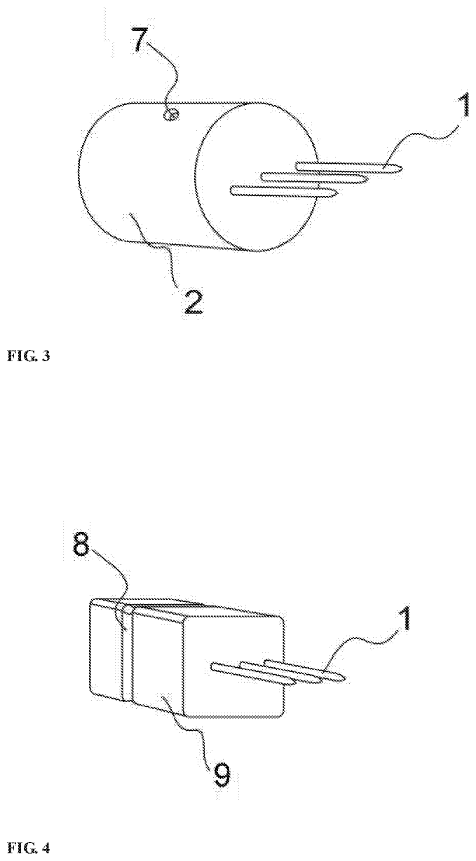

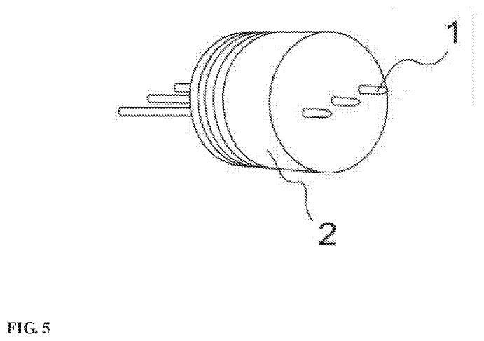

In FIG. 1, FIG. 2 FIG. 3, FIG. 5, the same numbers represent the same parts, the mapping relationships are as follows: 1, The needle bodies; 2, The circular cylindrical body; 3, The screw thread; 4, The screw cap; 5, The longitudinal bulges; 6, The longitudinal grooves; 7, The hole; 8, The transverse groove; 9, The square body.

### The Specific Implementation Methods

Put the needle bodies (1) of the present invention towards the seam of the ceramic tile wall, insert it into the seam of the ceramic tile by the external force of hammer.

In the present invention, the method to fix shelves in the first embodiment and the second embodiment is: Put the shelf with a corresponding hole to sleeve on the circular cylindrical body (2). then screw the screw cap (4) by the screw thread (3), to fix the shelf.

The first embodiment of the present invention can adapt to the ceramic tile seams in any direction: horizontal, vertical and any mosaic directions.

The second embodiment mainly adapt to the ceramic tile seams in both horizontal and vertical directions, it can achieve that a single ceramic tile seam nail to fix shelf.

In the third embodiment and the fourth embodiment, the method to fix shelves is: Put the shelf with a corresponding hole to sleeve on the circular cylindrical body (2) or the square body (9), to fix the shelf by an ordinary nail in the holes (7) on the circular cylindrical body (2), or on the transverse grooves (8) on the square body (9). This method is very common in the application of the kitchen and bathroom products. By this way, the third and the fourth embodiment provide more options to fix a shelf by a single ceramic tile seam nail.

The fourth embodiment is mainly applicable to the ceramic tile seams in both horizontal and vertical directions.

The present invention can also be used on ordinary walls, wardrobes or other furniture. Because the ceramic tiles are much stronger than the ordinary walls, In the case that the invention is applied on the ceramic tile walls, the ceramic tile seam nails can bear the ultimate load without worrying about the wall damaged (in the application of house decoration, it usually happens that the wall is damaged, but the nails are rarely damaged).

1. A ceramic tile seam nail, comprising needle bodies (1) penetrating a circular cylindrical body (2), characterized in that: there are holes (7) on the outer wall of said circular cylindrical body, unlimited the number of the holes.

2. A ceramic tile seam nail, comprising needle bodies (1) penetrating a circular cylindrical body (2), characterized in that: there is a screw thread (3) on one end of the outer wall of said circular cylindrical body, with a corresponding screw cap (4).

3. A ceramic tile seam nail, comprising needle bodies (1) penetrating a circular cylindrical body (2), characterized in that: there is a screw thread (3) on one end of the outer wall of said circular cylindrical body, with a corresponding screw cap (4), the longitudinal bulges (5) are created from the adjacent screw thread (3) to the other end.

4. A ceramic tile seam nail, comprising the needle bodies (1) penetrating a circular cylindrical body (2), characterized in that: there is a screw thread (3) on one end of the outer wall of said circular cylindrical body, with a corresponding screw cap (4), the longitudinal grooves (6) are created from the adjacent screw thread (3) to the other end.

5. A ceramic tile seam nail, comprising the needle bodies (1) penetrating a square body (9), characterized in that: there are holes on the outer wall of said square body, unlimited the number of the holes.

6. A ceramic tile seam nail, comprising the needle bodies (1) penetrating a square body (9), characterized in that: the transverse groove (8) is created on said square body.

7. A ceramic tile seam nails according to claim 1, or 2, or 3, or 4, or 5, or 6, characterized in that: several said needle bodies, arranged in a line.
